(19) United States
(12) Patent Application Publication
(10) Pub. No.: US 2009/0076814 A1
(43) Pub. Date: Mar. 19, 2009

(54) Apparatus and method for determining speech signal

(75) Inventor: Sung Joo Lee, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/149,727

(22) Filed: May 7, 2008

(30) Foreign Application Priority Data
Sep. 19, 2007 (KR) 10-2007-0095375

(51) Int. Cl. G10L 15/20; G10L 15/00

(52) U.S. Cl. 704/233; 704/E15.039; 704/E15.001

(57) ABSTRACT

Provided are a method and apparatus for discriminating a speech signal. The apparatus for discriminating a speech signal includes: an input signal quality improver for reducing additional noise from an acoustic signal received from outside; a first start/end-point detector for receiving the acoustic signal from the input signal quality improver and detecting an end-point of a speech signal included in the acoustic signal; a voiced-speech feature extractor for extracting voiced-speech features of the input signal included in the acoustic signal received from the first start/end-point detector; a voiced-speech/unvoiced-speech discrimination model for storing a voiced-speech model parameter corresponding to a discrimination reference of the voiced-speech feature parameter extracted from the voiced-speech feature extractor; and a voiced-speech/unvoiced-speech discriminator for discriminating a voiced-speech portion using the voiced-speech features extracted by the voiced-speech feature extractor and the voiced-speech discrimination model parameter of the voiced/unvoiced-speech discrimination model.

### CROSS-REFERENCE TO RELATED APPLICATION

This application claims priority to and the benefit of Korean Patent Application No. 10-2007-0095375, filed Sep. 19, 2007 the disclosure of which is incorporated herein by reference in its entirety.

### BACKGROUND

1. Field of the Invention

The present invention relates to a method and apparatus for determining a speech signal, and more particularly, to a method and apparatus for distinguishing between speech and non-speech using a voiced-speech feature of human voice.

2. Discussion of Related Art

There are many obstacles to prevent commercializing an automatic speech recognition (ASR) system in real environments. The presence of actual noise should be solved among them. The preprocessor of ASR system should detect noise portions of input signal to estimate the statistical characteristics and enhance the quality of input signal by removing the noise components form input signal. The speech end-point detecting system should detect user's speech portions in an adverse environment including various noise sources (TV, Radio, Vacuum Cleaner, Air Conditioner, etc.). In the case of Non-Push-To-Talk (NON-PTT) condition, in this condition a user don't need to push a button just before a talk, various noise signals are able to interrupt ASR system. Actually, these interferences often cause speech recognition performance degradation.

In order to recognize speech in NON-PTT mode, speech or non-speech discrimination technology is essential. Unfortunately, it is not easy to distinguish speech portions in the presence of music or babble using conventional methods because the characteristics of these noise signals are similar with the speech.

### SUMMARY OF THE INVENTION

The present invention is directed to a method and apparatus for discriminate speech portions using a voiced feature of human speech

The present invention is also directed to voiced-speech detection technology which solves a performance degradation problem of conventional speech/non-speech discrimination techniques in various noisy environments. This technology is based on the voiced-speech detection technology and is highly robust in the presence of adverse noises.

One aspect of the present invention provides an apparatus for discriminating speech signal, comprising: an input signal quality improver for reducing additional noise received from an acoustic signal received from outside; a first start/end-point detector for receiving the acoustic signal from the input signal quality improver and detecting an start/end-point of a speech signal included in the acoustic signal; a voiced-speech feature extractor for extracting a voiced-speech feature included in the acoustic signal received from the first start/end-point detector; a voiced-speech/unvoiced-speech discrimination model for storing voiced-speech discrimination model parameters corresponding to a discrimination reference of the voiced-speech features extracted from the voiced-speech feature extractor; and a voiced-speech/unvoiced-speech discriminator for discriminating a voiced-speech portion using the voiced-speech feature extracted by the voiced-speech feature extractor and the voiced-speech discrimination model parameter of the voiced-speech/unvoiced-speech discrimination model.

The apparatus may further comprise a second start/end-point detector for refining the start/end-point of the speech signal included in the received acoustic signal on the basis of the determination result of the speech/non-speech discriminator and the detection result of the first start/end-point detector. wherein the input signal quality improver may output the time-domain signal from which the additional noise is reduced by one of Wiener method, Minimum Mean-Square Error (MMSE) method and Kalman method.

In addition, the voiced-speech feature extractor extracts a modified Time-Frequency (TF) parameter, and High-to-Low Frequency Band Energy Ratio (HLFBER), tonality, Cumulative Mean Normalized Difference Valley (CMNDV), Zero-Crossing Rate (ZCR), Level-Crossing Rate (LCR), Peak-to-Valley Ratio (PVR), Adaptive Band-Partitioning Spectral Entropy (ABPSE), Normalized Autocorrelation Peak (NAP), spectral entropy, and Average Magnitude Difference Valley (AMDV) feature parameters from the received continuous speech signal. The voiced-speech/unvoiced-speech discrimination model includes one of threshold and boundary values of each voiced-speech feature extracted from a pure speech model, and model parameters of Gaussian Mixture Model (GMM) method, MultiLayer Perception (MLP) method and Support Vector Machine (SVM) method. The voiced-speech/unvoiced-speech discriminator uses one of simple threshold and boundary method, the GMM method using a statistical model, the MLP method using artificial intelligence (AI), a Classification and Regression Tree (CART) method, and the SVM method.

In addition, the first start/end-point detector may detect the end-point of the speech signal included in the acoustic signal using time-frequency domain energy and an entropy-based feature of the received acoustic signal, determines whether the input signal is speech using a Voiced Speech Frame Ratio (VSFR), and provides speech marking information. The second start/end-point detector detects the end-point of the speech signal included in the acoustic signal using one of Global Speech Absence Probability (GSAP), Zero-Crossing Rate (ZCR), Level-Crossing Rate (LCR) and an entropy-based feature.

Another aspect of the present invention provides a method of determining a speech signal, comprising: receiving an acoustic signal from outside; reducing additional noise from the input acoustic signal; receiving the acoustic signal from which the additional noise is removed, and detecting a first start/end-point of a speech signal included in the acoustic signal; extracting voiced-speech feature parameters from the speech signal from which the first start/end-point is detected; and comparing the extracted voice-speech features with a predefined voiced-speech/unvoiced-speech discrimination model and discriminating a voiced-speech part of the input acoustic signal.

The method may further comprise detecting a second start/end-point of the speech signal included in the acoustic signal on the basis of the discriminated voiced-speech part. The additional noise is removed from the acoustic signal using one of Wiener method, Minimum Mean-Square Error (MMSE) method and Kalman method. The voiced-speech features are a modified Time-Frequency (TF) parameter, and High-to-Low Frequency Band Energy Ratio (HLFBER), tonality, Cumulative Mean Normalized Difference Valley (CMNDV), Zero-Crossing Rate (ZCR), Level-Crossing Rate (LCR), Peak-to-Valley Ratio (PVR), Adaptive Band-Partitioning Spectral Entropy (ABPSE), Normalized Autocorrelation Peak (NAP), spectral entropy and Average Magnitude Difference Valley (AMDV) feature parameters of the received continuous speech signal.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram of a speech recognition apparatus to which the present invention is applied;

FIG. 2 is a block diagram of a preprocessing unit according to an exemplary embodiment of the present invention;

FIG. 3 schematically illustrates a method of discriminating voiced speech/unvoiced speech portions according to an exemplary embodiment of the present invention;

FIG. 4 illustrates a method of extracting a feature for voiced speech/unvoiced speech discrimination according to an exemplary embodiment of the present invention; and

FIG. 5 illustrates a process of calculating a modified Time-Frequency (TF) parameter applied to the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

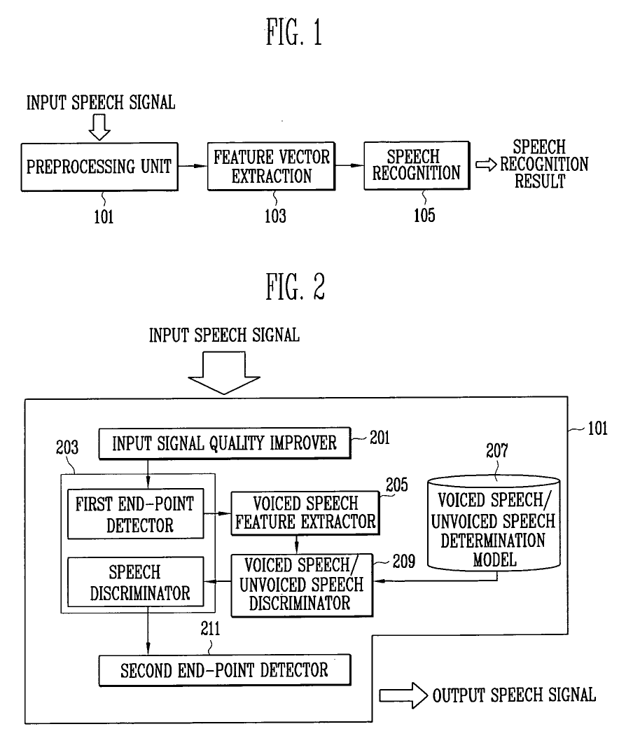

FIG. 1 is a block diagram of a speech recognition apparatus to which the present invention is applied.

Referring to FIG. 1, the speech recognition apparatus roughly comprises a preprocessing unit 101, a feature vector extraction unit 103 and a speech recognition unit 105.

When the speech recognition apparatus receives an acoustic signal including speech and noise from user in the case of Non-Push-To-Talk (NON-PTT) condition, the preprocessing unit 101 serves to enhance the quality of input signal by reducing additional noise components and then accurately distinguish a speech section corresponding to speech of a speaker. In comparison with a PTT condition in which a user should indicate the moment of speaking, it is very important for the continuous speech recognition to detect a speech section from non-speech section and accurately extract the speech section, which is a novel feature of the present invention.

When the preprocessing unit 101 separates a speech section, the feature vector extraction unit 103 converts the separated speech signal into various forms required for speech recognition. In general, a feature vector converted by the feature vector extraction unit 103 shows a feature of each phoneme appropriately for speech recognition and is not significantly changed according to an environment.

Using the feature vector extracted by the feature vector extraction unit 103, the speech recognition unit 105 recognizes speech on the basis of the feature vector. The speech recognition unit 105 determines a phoneme or phonetic value indicated by the feature vector using a statistical method, a semantic method, etc., based on an acoustic model and speech model, thereby recognizing what speech the input speech signal exactly corresponds to.

When the speech recognition is completed, the speech may be interpreted using a semantic model, or an order may be issued on the basis of the speech recognition result.

According to the speech recognition method, it is very important for a speech recognition apparatus receiving continuous speech to separate a speech section from a non-speech section.

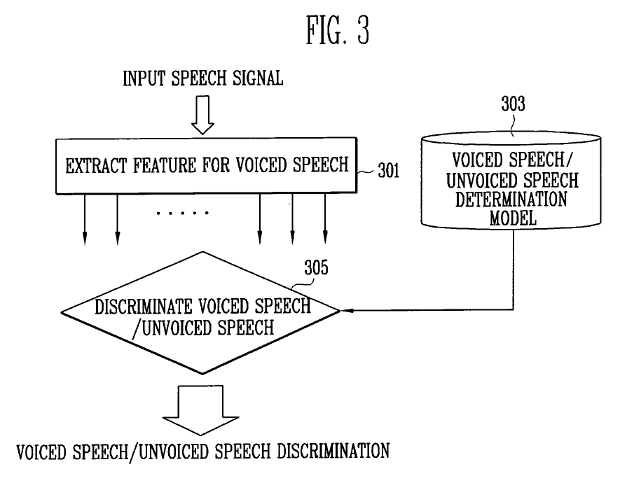

FIG. 2 is a block diagram of a preprocessing unit according to an exemplary embodiment of the present invention.

Referring to FIG. 2, a preprocessing unit 101 comprises an input signal quality improver 201, a first start/end-point detector and speech/non-speech discriminator 203, a voiced-speech feature extractor 205, a predefined voiced-speech/unvoiced-speech discrimination model 207, a voiced-speech/unvoiced-speech discriminator 209 and a second start/end-point detector 211.

The above mentioned constitution of the preprocessing unit is just an exemplary embodiment of the present invention, and a variety of embodiments may be available within the scope of the present invention.

First, the input signal quality improver 201 removes additional noise from an acoustic signal including a speech signal and a noise signal, thereby serving to minimize deterioration of the input signal's sound quality due to the noise. In general, the additional noise may be background noise of a single channel continuously heard while a speaker speaks. To remove such noise, Wiener method, Minimum Mean-Square Error (MMSE) method and Kalman method may be used.

The Wiener method and MMSE method estimate clean speech component based on Minimum-Mean-Square-Error (MMSE) criterion but some assumptions to solve the problem are different from each other. Kalman method is a recursive computational solution to track time-dependent state vector based on least square criterion. All the methods are appropriate for removing Gaussian noise or uniform noise.

The MMSE method can be seen in “Speech Enhancement Using a Minimum Mean-Square Error Short-Time Spectral Amplitude Estimator” (Y. Ephraim and D. Malah, Institute of Electrical and Electronics Engineers (IEEE) Transactions on Acoustics, Speech and Signal Processing, Vol. ASSP-32, No. 6, pp. 1109-1121, December 1984). The Wiener filter can be seen in a European Telecommunications Standards Institute (ETSI) standard document “Speech Processing, Transmission and Quality Aspects (STQ); Distributed Speech Recognition; Advanced front-end feature extraction algorithm; Compression Algorithm,” (ETSI European Standard (ES) 202 050 v1.1.1, 2002-10). The Kalman method can be seen in “Iterative and Sequential Kalman Filter-Based Speech Enhancement Algorithms,” (Sharon Gannot, David Burshtein, Ehud Weinstein, IEEE Transactions on Speech and Audio Processing, VOL. 6, No. 4, pp. 373-385, July 1998).

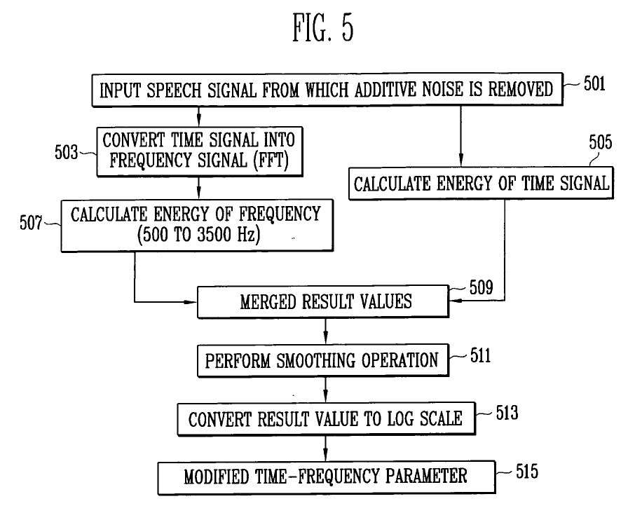

The voiced-speech feature extractor 205 serves to extract a voiced-speech feature from the speech signal received from the input signal quality improver 201. When a noise signal having speech-like feature, such as music noise, babble noise, etc., it is difficult to distinguish between a speech signal of a speaker and noise using a conventional speech/non-speech discrimination method. In the present invention, 11 kinds of speech features denoting a voiced-speech characteristic are extracted by a voiced-speech feature extractor to distinguish between speech and non-speech, and thus it is possible to separate noises which are difficult to distinguish using conventional methods. The 11 voiced-speech feature parameters and a speech extraction method will be described in FIG. 4.

In the case of simple threshold and boundary method, the predefined voiced-speech/unvoiced-speech discrimination model 207 stores threshold or boundary values estimated with clean voiced-speech database. In other words, the predefined voiced-speech/unvoiced-speech discrimination model 207 stores threshold or boundary information whereby it can be determined whether the feature extracted by the voiced-speech feature extractor 205 corresponds to actual voiced-speech of human. The model parameters stored in the voiced-speech/unvoiced-speech discrimination model 207 may vary according to a discrimination method used by the voiced-speech/unvoiced-speech discriminator 209, which will be described below For example, In the case of Gaussian Mixture Model (GMM) method, The predefined voiced-speech/unvoiced-speech discrimination model 207 may store the GMM model parameters which are estimated using voiced-speech database. In the case of MultiLayer Perceptron (MLP) method, MLP parameters may be kept. In the case of Support Vector Machine (SVM) method, SVM parameters may be used to classify voiced/unvoiced speech portions. In the case of Classification and Regression Tree (CART) method, CART tree classifier parameters may be predefined using voiced-speech database.

Where, in the case of GMM method, Probability Density Functions (PDF) which indicates Gaussian distribution property are estimated using statistical techniques. Among classification methods using a neural network, MLP method is widely used. An MLP indicates a feed-forward neural network model consisting of an input layer, a hidden layer consisting of hidden nodes, and an output layer.
In addition, SVM method is one of the non-linear classification methods based on statistical learning theory. According to SVM method, a decision function is estimated using probability distribution obtained from diagnosis of learning training data and category information in a learning process, and then new data is dualistically classified according to the estimated decision function. The CART method classifies a pattern using a CART structure, thus classifying data on the basis of a branching tree.
The voiced-speech/unvoiced-speech discriminator 209 compares the 11 voiced-speech features extracted by the voiced-speech feature extractor 205 with the predefined voiced-speech/unvoiced-speech discrimination model 207, thereby serving to determine whether the input speech signal is voiced-speech of human.

According to embodiments and needs, the voiced-speech/unvoiced-speech discriminator 209 may simply compare the voiced-speech feature with the predefined threshold or boundary values in the case of simple threshold and boundary method, or the voiced-speech/unvoiced-speech discriminator 209 may use GMM method, MLP method, SVM method, CART method, and so on.

The first start/end-point detector 203 detects a start-point or end-point of speech using time-frequency domain energy, an entropy-based feature, etc., of the speech signal. After a start-point of speech is detected, the first start/end-point detector 203 serves to transfer the speech signal to the voiced-speech feature extractor 205. And then, the voiced-speech feature extracted by the voiced-speech feature extractor 205 is transfer to the voiced-speech/unvoiced-speech discriminator 209. The voiced-speech/unvoiced-speech discriminator 209 detects voiced-speech portions using the voiced-speech feature and the voiced-speech discrimination result is transferred to the speech/non-speech discriminator 203. Finally, the speech/non-speech discriminator 203 determines whether the input signal is speech using Voiced Speech Frame Ratio (VSFR). The VSFR can be estimated using the results of the voiced-speech/unvoiced-speech discriminator 209. When the input signal is identified as non-speech signal, the first start/end-point detector 203 rejects the start-point detected or end-point detected signal stream and keep searching a start-point and end-point of speech.

Here, the VSFR indicates a ratio of voiced-speech frame number to entire speech frame number. The total speech frame number can be counted using the first start/end-point detector 203 output frames. In general, human speech signal consists of voiced and voiced-speech portions. Therefore, it is possible to distinguish between speech and non-speech signal using this property. That is, if the output signal of the first start/end-point detector 203 is a human speech signal, it should have a certain amount of voiced-speech portions. By comparing the VSFR with the predefined threshold value, speech signals can be discriminated from non-speech signals.

After a certain number of speech frames are detected by the first start/end-point detector 203, the speech/non-speech discriminator 203 start to calculate VSFR using the results from to the voiced-speech/unvoiced-speech discriminator 209. By comparing the VSFR with a predefined threshold, the output signal stream from the first start/end-point detector 203 can be identify as speech or non-speech. If speech is discriminated in this process, the first start/end-point detector 203 will reject its output signal stream and then start to find speech start-point again. This discrimination will be continued until speech-endpoint is detected. When speech start-point is detected, the speech signal stream is transfer to the second start/end-point detector 211. If the speech signal stream is identified as non-speech by the speech/non-speech discriminator 203, the second start/end-point detector 211 will reject the speech signal stream, too. If the signal stream is identified as speech until the speech discrimination process ends, the signal steam will be accepted. Since the speech/non-speech discrimination process is based on VSFR, accurate voiced-speech frame detection process is essential in this invention.

The second start/end-point detector 211 serves to refine a start-point and end-point of speech using the output signal from the first start/end-point detector 203. To find such an accurate start or end-point of speech, one of Global Speech Absence Probability (GSAP), Zero Crossing Rate (ZCR), Level-Crossing Rate (LCR), and entropy-based feature can be used.

Here, GSAP indicates Speech Absence Probability (SAP) estimated in every speech frame.

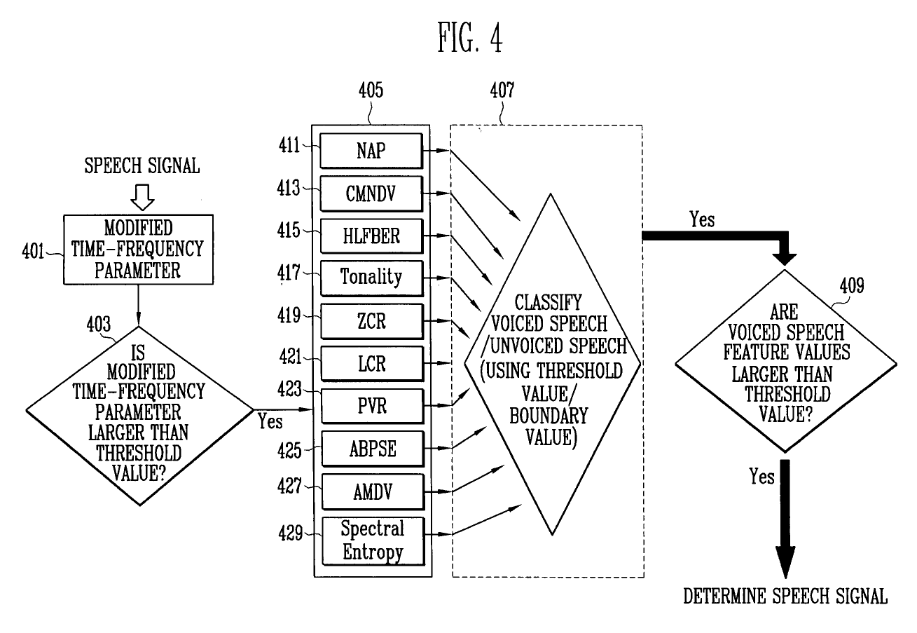

FIG. 3 schematically illustrates a method of discriminating voiced speech/unvoiced speech portions according to an exemplary embodiment of the present invention, at the voiced-speech/unvoiced-speech discriminator described in FIG. 2.

Referring to FIG. 3, when a speech signal is input, the voiced-speech feature extractor extracts 11 kinds of voiced-speech feature (step 301). Using the 11 features, it is possible to discriminate between speech and speech-like signal (music, babble, and etc.), which are difficult to distinguish using conventional methods. The 11 features indicates modified TF parameter, High-to-Low Frequency Band Energy Ratio (HLFBER), tonality, Cumulative Mean Normalized Difference Valley (CMNDV), ZCR, LCR, Peak-to-Valley Ratio (PVR), Adaptive Band-Partitioning Spectral Entropy (ABPSE), Normalized Autocorrelation Peak (NAP), spectral entropy, and Average Magnitude Difference Valley (AMDV) feature, which will be described in FIG. 4.

The features may be roughly categorized into time-domain feature, such as a normalized auto-correlation function, and entropy-based frequency-domain feature.

When the voiced-speech features are extracted from the quality enhanced signal, it is possible to discriminate between voiced and unvoiced speech using the voiced-speech/unvoiced-speech discrimination model 303. The discrimination of voiced/unvoiced speech may be conducted by simple comparison in the case of simple threshold method. In the case of GMM method, MLP method, SVM method, CART method, the voiced/unvoiced speech discrimination method depends on each criterion respectively (step 305).

FIG. 4 illustrates a method of extracting a feature for voiced speech/unvoiced speech discrimination according to an exemplary embodiment of the present invention.

Referring to FIG. 4, modified TF parameter 401 is estimated before other voiced-speech feature extraction. A method of calculating the modified TF parameter 401 will be described in FIG. 5. In general, voiced-speech portions have more energy than unvoiced-speech portions. Therefore, voiced-speech portions can be roughly discriminated by modified TF parameter 401. If the modified TF feature of the current frame is larger than the predefined threshold stored in the voiced-speech/unvoiced-speech discrimination model 303, the current frame can be roughly identified as voiced-speech (step 403). And then, other voiced-speech feature are estimated; HLFBER 415, tonality 417, CMNDV 413, ZCR 419, LCR 421, PVR 423, ABPSE 425, NAP 411, spectral entropy 429, and AMDV 427. This routine can reduce the computational complexity of the voiced-speech feature extractor 205.

Meanings and calculation methods of the voiced-speech features will be described. First, the HLFBER 415 is a feature using the speech characteristics that voiced sound has high energy in a low frequency domain, and can be calculated by the following formula:

$$HLFBER = \frac{highbandE}{lowbandE}$$

$$highbandE 4 ∼ 8 kHz band energy$$

$$lowbandE 0 ∼ 4 kHz band energy .$$

The tonality 417 indicates a voiced-speech feature consisting of tone and harmony components, and can be calculated by the formula below. In this formula, ax denotes tonality.

$$α = min ( \frac{{SFM}_{dB}}{{SFM}_{dB max}} , 1 ) , {SFM}_{dB max} = - 60$$

$${SFM}_{dB} = 10 {log}_{10} \frac{Geometric Mean}{Arithmetic Mean}$$

The CMNDV 413 is calculated on the basis of a YIN algorithm. The CMNDV 413 is a feature parameter representing a periodic feature of voiced speech and has similar characteristics with the maximum of a normalized self-correlation function.

$${d}_{τ} ( τ ) = {\sum }_{j = 1}^{W} {( {x}_{j} - {x}_{j + τ} )}^{2}$$

where d_{τ}(τ) is the difference function of lag τ calculated a time index t, and W is the integration window size. The cumulative mean normalized difference function

$${d}_{τ}^{′} ( τ ) = \{ \begin{matrix}1 , & if τ = 0 , \\ \frac{{d}_{τ} ( τ )}{[ ( 1 / τ ) {\sum }_{j = 1}^{τ} {d}_{τ} ( j ) ]} , & otherwise\end{matrix}$$

The CMNDV can be calculated as following,

CMVDV=min{d′_{τ}(τ)},τₘᵢₙ≦τ≦τₘₐₓ

where the range of r is the pitch lag range

The ZCR 419 and the LCR 421 are parameters representing frequency features of voiced-speech.

The ZCR is the rate of sign-changes along a signal, the rate at which the signal changes from positive to negative or back. This feature has been used heavily in both speech recognition and music information retrieval and is defined formally as

$$ZCR = {\sum }_{n = 0}^{L - 1} \frac{1 - sign [ x ( n ) ] \times sign [ x ( n + 1 ) ]}{2}$$

where L is the window size

$$sign [ x ( n ) ] = \{ \begin{matrix}1 , & if x ( n ) \geq 0 \\ - 1 , & if x ( n ) < 0\end{matrix}$$

LCR is estimated throughout 3 level center clipping method

$$y ( n ) = sgn [ x ( n ) ] = \{ \begin{matrix}1 , & if x ( n ) \geq CL \\ 0 , & if \vert x ( n ) \vert < CL \\ - 1 , & if x ( n ) \leq - CL\end{matrix}$$

where CL indicates the clipping threshold, LCR is calculated as follows,

$$LCR = {\sum }_{n = 0}^{L - 1} \vert sgn [ x ( n ) ] - sgn [ x ( n + 1 ) ] \vert$$

The PVR 423 is a feature parameter representing periodicity of voiced-speech level. After obtaining a half-wave rectified input signal and its autocorrelation function, find the highest and lowest values of the autocorrelation function. The PVR 423 is obtained by calculating the ratio of the highest value to the lowest value. The half-wave rectified output signal can be obtained as follows,

y(n)=|x(n)|

Autocorrelation function can be calculated as follows,

$${R}_{xx} ( k ) = \frac{{\sum }_{n = 0}^{L - 1 - k} x ( n ) x ( n + k )}{L - k} . \\ PVR = \frac{max [ {R}_{xx} ( k ) ]}{min [ {R}_{xx} ( k ) ]} , {k}_{min} \leq k \leq {k}_{max}$$

where the above search is identical to the pitch lag range
The ABPSE 425 and the spectral entropy 429 are features representing spectral and harmonic characteristics of voiced speech.
These feature parameters can be seen in “Robust Endpoint Detection Algorithm Based on the Adaptive Band-Partitioning Spectral Entropy in Adverse Environments” (Bing-Fei Wu and Kun-Ching Wang, IEEE Transactions on Speech and Audio Processing, Vol. 13, No. 5, September 2005).

The NAP 411 and the AMDV 427 are feature parameters representing periodic characteristics of voiced speech.

The normalized autocorrelation function is as follows,

$${NR}_{xx} ( k ) = \frac{{\sum }_{n = 0}^{L - 1 - k} x ( n ) x ( n + k )}{{[ {\sum }_{n = 0}^{L - 1 - k} {x}^{2} ( n ) {\sum }_{n = 0}^{L - 1 - k} {x}^{2} ( n + k ) ]}^{1 / 2}}$$

The NAP can be estimated as follows,

NAP=max[NRₓₓ(k)],kₘᵢₙ≦k≦kₘₐₓ

where the above search is identical to the pitch lag range.
The Average Magnitude Difference Function as follows,

$${AMDF}_{t} ( τ ) = \frac{1}{L - 1 - τ} {\sum }_{n = 0}^{L - 1 - τ} \vert x ( n ) - x ( n + τ ) \vert$$

The AMDV is found by searching for the valley of average magnitude difference function,

AMDV=min[AMDF_{τ}(τ)],τₘᵢₙ≦τ≦τₘₐₓ

Where, the above search is identical to the pitch lag range
Such voiced-speech features are almost never used by conventional preprocessing methods. When all the feature parameters are determined, voiced-speech portions can be discriminated remarkably well comparing with the conventional voiced-speech discrimination methods.

The voiced-speech features calculated in this way may be classified by a voiced/unvoiced-speech classification method (407). Among voiced-speech/unvoiced-speech classification methods, the simplest comparison method using the predefined threshold or boundary value is shown in FIG. 4.

If all the voiced-speech features are larger than the predefined thresholds or in the predefined boundaries, the current frame will be classified as voiced-speech.

FIG. 5 illustrates a process of calculating a modified Time-Frequency (TF) parameter applied to the present invention.

Among the voiced-speech features used in the present invention, a modified TF parameter is calculated at first. As shown in FIG. 5, when the enhanced speech signal comes in (step 501), time-domain energy estimation (step 505) and frequency-domain analysis (step 503) start. On the frequency-domain analysis part, the time-domain signal is converted into frequency components using Fast Fourier Transform (FFT) (step 503). And then, the noise robust band energy is estimated (step 507). The noise robust frequency band has frequency range from 500 Hz to 3500 Hz.

After time-domain energy and noise robust frequency band energy estimation, the estimated values are merged (step 509). And then, a smoothing operation is performed (step 511). Subsequently, the result value is converted to a log scale (step 513). Through these steps, a modified TF parameter is calculated (step 515).

According to the present invention, it is possible to provide a method and apparatus for discriminating speech using the voiced-speech feature.

In addition, according to the present invention, it is possible to provide voiced-speech detection technology, which solves the performance degradation problem of conventional speech/non-speech discrimination techniques in various noisy environments because of its noise robustness.

While the invention has been shown and described with reference to certain implementation example thereof, it will be understood by those skilled in the art that various changes in form and details may be made therein without departing from the spirit and scope of the invention as defined by the appended claims.

1. An apparatus for discriminating speech signal, comprising:
an input signal quality improver for reducing additional noise received from an acoustic signal received from outside;
a first start/end-point detector for receiving the acoustic signal from the input signal quality improver and detecting an start/end-point of a speech signal included in the acoustic signal;
a voiced-speech feature extractor for extracting a voiced-speech feature included in the acoustic signal received from the first start/end-point detector;
a voiced-speech/unvoiced-speech discrimination model for storing voiced-speech discrimination model parameters corresponding to a discrimination reference of the voiced-speech features extracted from the voiced-speech feature extractor; and
a voiced-speech/unvoiced-speech discriminator for discriminating a voiced-speech portion using the voiced-speech feature extracted by the voiced-speech feature extractor and the voiced-speech discrimination model parameter of the voiced-speech/unvoiced-speech discrimination model.

2. The apparatus of claim 1, further comprising:
a second start/end-point detector for refining the start/end-point of the speech signal included in the received acoustic signal on the basis of the determination result of the speech/non-speech discriminator and the detection result of the first start/end-point detector.

3. The apparatus of claim 1, wherein the input signal quality improver may output the time-domain signal from which the additional noise is reduced by one of Wiener method, Minimum Mean-Square Error (MMSE) method and Kalman method.

4. The apparatus of claim 1, wherein the voiced-speech feature extractor extracts a modified Time-Frequency (TF) parameter, and High-to-Low Frequency Band Energy Ratio (HLFBER), tonality, Cumulative Mean Normalized Difference Valley (CMNDV), Zero-Crossing Rate (ZCR), Level-Crossing Rate (LCR), Peak-to-Valley Ratio (PVR), Adaptive Band-Partitioning Spectral Entropy (ABPSE), Normalized Autocorrelation Peak (NAP), spectral entropy, and Average Magnitude Difference Valley (AMDV) feature parameters from the received continuous speech signal.

5. The apparatus of claim 1, wherein the voiced-speech/unvoiced-speech discrimination model includes one of threshold and boundary values of each voiced-speech feature extracted from a pure speech model, and model parameters of Gaussian Mixture Model (GMM) method, MultiLayer Perception (MLP) method and Support Vector Machine (SVM) method.

6. The apparatus of claim 1, wherein the voiced-speech/unvoiced-speech discriminator uses one of simple threshold and boundary method, the GMM method using a statistical model, the MLP method using artificial intelligence (AI), a Classification and Regression Tree (CART) method, and the SVM method.

7. The apparatus of claim 1, wherein the first start/end-point detector may detect the end-point of the speech signal included in the acoustic signal using time-frequency domain energy and an entropy-based feature of the received acoustic signal, determines whether the input signal is speech using a Voiced Speech Frame Ratio (VSFR), and provides speech marking information.

8. The apparatus of claim 2, wherein the second start/end-point detector detects the end-point of the speech signal included in the acoustic signal using one of Global Speech Absence Probability (GSAP), Zero-Crossing Rate (ZCR), Level-Crossing Rate (LCR) and an entropy-based feature.

9. A method of determining a speech signal, comprising:
receiving an acoustic signal from outside;
reducing additional noise from the input acoustic signal;
receiving the acoustic signal from which the additional noise is removed, and detecting a first start/end-point of a speech signal included in the acoustic signal;
extracting voiced-speech feature parameters from the speech signal from which the first start/end-point is detected; and
comparing the extracted voice-speech features with a predefined voiced-speech/unvoiced-speech discrimination model and discriminating a voiced-speech part of the input acoustic signal.

10. The method of claim 9, further comprising:
detecting a second start/end-point of the speech signal included in the acoustic signal on the basis of the discriminated voiced-speech part.

11. The method of claim 9, wherein the additional noise is removed from the acoustic signal using one of Wiener method, Minimum Mean-Square Error (MMSE) method and Kalman method.

12. The method of claim 9, wherein the voiced-speech features are a modified Time-Frequency (TF) parameter, and High-to-Low Frequency Band Energy Ratio (HLFBER), tonality, Cumulative Mean Normalized Difference Valley (CMNDV), Zero-Crossing Rate (ZCR), Level-Crossing Rate (LCR), Peak-to-Valley Ratio (PVR), Adaptive Band-Partitioning Spectral Entropy (ABPSE), Normalized Autocorrelation Peak (NAP), spectral entropy and Average Magnitude Difference Valley (AMDV) feature parameters of the received continuous speech signal.

13. The method of claim 9, wherein the voiced-speech/unvoiced-speech discrimination model includes one of threshold values and boundary values of each voiced-speech feature extracted from clean speech database, and model parameter values of a Gaussian Mixture Model (GMM) method, a MultiLayer Perception (MLP) method and a Support Vector Machine (SVM) method. All the model parameters are estimated from clean speech database.

14. The method of claim 9, wherein the voiced-speech portion is discriminated using one of simple threshold and boundary method, the GMM method using a statistical model, the MLP method using artificial intelligence (AI), a Classification and Regression Tree (CART) method, and the SVM method.

15. The method of claim 9, wherein the step of detecting a first end-point further comprises
detecting a start-point and the end-point of the speech signal included in the acoustic signal using an End-Point Detection (EPD) method.
